(19) United States
(12) Patent Application Publication
(10) Pub. No.: US 2004/0013882 A1
(43) Pub. Date: Jan. 22, 2004

(54) Multi-layer product containing polycarbonate

(76) Inventors: Rudiger Gorny, Moon Twp, PA (US); Siegfried Anders, Koln (DE); Wolfgang Nising, St. Augustin (DE); Jurgen Rohner, Koln (DE); Marco Roelofs, Krefeld (DE); Silke Kratschmer, Frankfurt (DE)

Correspondence Address: BAYER POLYMERS LLC, 100 BAYER ROAD, PITTSBURGH, PA, 15205, US

(21) Appl. No.: 10/613,726

(22) Filed: Jul. 3, 2003

(30) Foreign Application Priority Data
Jul. 10, 2002 (DE) 10230983.3

(51) Int. Cl. B32B 27/36

(52) U.S. Cl. 428/412

(57) ABSTRACT

A multi-layer product comprising a coex layer and a base layer is disclosed. The coex layer contains a copolycarbonate derived from repeat units having the formula (I)

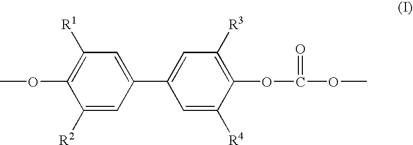

where R¹ to R⁴ are defined and repeat units having the formula (II)

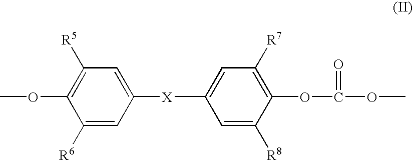

where R⁵ to R⁸ and X are defined. The base layer contains a polycarbonate characterized in that its chemical resistance is lesser than that of said copolycarbonate. The product is characterized by its improved resistance to chemical attack. Also disclosed are a uses of, and a method for producing the product.

### FIELD OF THE INVENTION

The present invention concerns a multi-layer product and more particularly to such product that contains polycarbonate.

### SUMMARY OF THE INVENTION

A multi-layer product comprising a coex layer and a base layer is disclosed. The coex layer contains a copolycarbonate derived from repeat units having the formula (I)

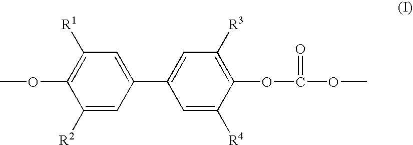

where R¹ to R⁴ are defined and repeat units having the formula (II)

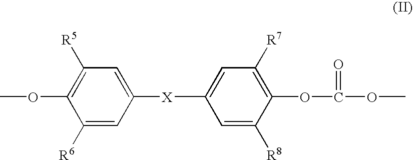

where R⁵ to R⁸ and X are defined. The base layer contains a polycarbonate characterized in that its chemical resistance is lesser than that of said copolycarbonate. The product is characterized by its improved resistance to chemical attack. Also disclosed are a uses of, and a method for producing the product.

### TECHNICAL BACKGROUND OF THE INVENTION

Bisphenol A-based homopolycarbonate has the disadvantage of not being sufficiently chemically resistant and thus unsuitable for some applications. The same also applies to many other polycarbonates based on dihydroxy compounds other than bisphenol A.

Copolycarbonates containing structural units derived from 4,4′-dihydroxydiphenylene (DOD) (so-called DOD copolycarbonates, also known as DOD-CoPC) have a higher chemical resistance than bisphenol A homopolycarbonate. However, these DOD-CoPCs cannot be used in some applications as they are more expensive than bisphenol A homopolycarbonate and as they are inferior to bisphenol A homopolycarbonate in terms of other properties.

Sheets having good chemical resistance are known. They are produced for example from polyethylene terephthalate (PET) or copolyesters such as e.g. PETG or polymethyl methacrylate (PMMA). These polymers have significantly lower notched impact resistance values than bisphenol A-based homopolycarbonate and are therefore not suitable for all applications.

The use of bisphenol A-based homopolycarbonate for sheets that are intended to be chemically resistant is known. In these cases either a chemically resistant coating is applied to the polycarbonate or it is laminated with a film made from a chemically resistant material.

The use of blends of bisphenol A homopolycarbonate with other polymers is known to increase the chemical resistance. In many cases these blends have the disadvantage of either not being transparent or at least of displaying a marked haze. The transparent polycarbonate blends display notched impact resistance values well below those of bisphenol A homopolycarbonate.

Other prior art relating to multi-layer products is summarised below.

EP-A 0 110 221 discloses sheets consisting of two layers of polycarbonate, whereby one layer contains at least 3 wt. % of a UV absorber. These sheets may be produced by coextrusion.

EP-A 0 320 632 discloses moldings consisting of two layers of thermoplastic, preferably polycarbonate, whereby one layer contains special substituted benzotriazoles as UV absorbers. The production of these moldings by coextrusion is also disclosed.

EP-A 0 247 480 discloses multi-layer sheets including a layer of branched polycarbonate that contains special substituted benzotriazoles as UV absorbers. The production of these sheets by coextrusion is also disclosed.

EP-A 0 500 496 discloses polymer compositions stabilized against UV light with special triazines and their use as an outer layer in multi-layer systems. Polycarbonate, polyesters, polyamides, polyacetals, polyphenylene oxide and polyphenylene sulfide are cited as polymers.

EP-A 0 825 226 discloses compositions consisting of polycarbonate, substituted aryl phosphites and substituted triazines. Multi-layer sheets in which one layer consists of the cited composition are also disclosed.

JP-A 02 028 239 discloses a film consisting of polyvinylidene fluoride and a polymethacrylate. A disadvantage of the film is that polyvinylidene fluoride is more expensive than polycarbonate.

JP-A 11 323 255 discloses a siloxane coating with perfluoroalkyl additives, which may be applied to polycarbonate to improve its chemical resistance.

U.S. Pat. No. 6,011,124 discloses a polymer mixture (blend) consisting of a polyester and a polycarbonate. This mixture is more chemically resistant, yet has a lower notched impact resistance, than polycarbonate.

EP-A 0 544 407, U.S. Pat. Nos. 5,532,324, 5,470,938 and 5,401,826 disclose copolycarbonates based on the bisphenols 4,4′-dihydroxydiphenyl and 2,2-bis-(4-hydroxyphenyl) propane. EP-A 0 544 407, U.S. Pat. Nos. 5,532,324, 5,470,938 and 5,401,826 also disclose that these copolycarbonates are fuel resistant, heat resistant and flame resistant and that the mechanical properties and transparency of these copolycarbonates are comparable with those of known polycarbonates.

The object of the present invention is to provide products that display a better chemical resistance than do products made from bisphenol A homopolycarbonate.

### DETAILED DESCRIPTION OF THE INVENTION

This object is achieved by a multi-layer product comprising a first and a second layer, where the first layer contains a copolycarbonate having 0.1 to 46 mol %, preferably 11 to 34 mol %, and in particular 26 to 34 mol %, of one or more repeat units having the formula

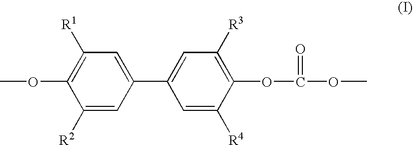

wherein R¹ to R⁴ mutually independently denote H, C₁ to C₄ alkyl, phenyl, substituted phenyl or halogen, and 99.9 to 54 mol %, preferably 89 to 0.66 mol % and in particular 74 to 66 mol %, of one or more repeat units having the formula (II)

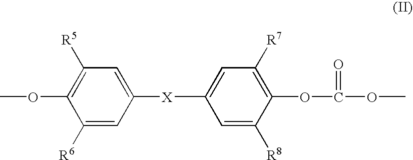

wherein R⁵ to R⁸ are mutually independently H, CH₃, Cl or Br and X is C₁ to C₅ alkylene, C₂ to C₅ alkylidene, C₅ to C₆ cycloalkylene, or C₅ to C₁₀ cycloalkylidene, and where the total amount of repeat units according to formula (I) and formula (II) is 100 mol %, and where the second layer contains a polycarbonate that is less chemically resistant than the copolycarbonate of the first layer.

Preferably R¹ to R⁴ mutually independently denote H, C₁-C₄ alkyl or halogen and particularly preferably all are identical, most particularly all denote H or tert.-butyl.

The particularly preferred copolycarbonates constitute 34-26 mol %, especially 33-27 mol %, in particular 32-28 mol %, most especially 31-29 mol % and most outstandingly 30 mol % of structural units derived from monomers having formula (I), supplemented in each case by a complementary content of units derived from monomers having formula (II).

Preferred repeat units having formula (I) are derived from 4,4′-dihydroxydiphenyl (DOD) and 4,4′-dihydroxy-3,3′,5,5′-tetra-(tert.-butyl) diphenyl.

Preferred repeat units having formula (II) are derived from 2,2-bis-(4-hydroxyphenyl) propane, 1,1-bis-(4-hydroxyphenyl)-3,3,5-trimethyl cyclohexane and 1,3-bis-[2-(4-hydroxyphenyl)-2-propyl] benzene, 1,1-bis-(4-hydroxyphenyl)-1-phenyl ethane, 1,1-bis-(4-hydroxyphenyl) cyclohexane, in particular 2,2-bis-(4-hydroxyphenyl) propane (bisphenol A).

Both one repeat unit having formula (I), forming binary copolycarbonates, and several repeat units having formula (I) may be used.

Likewise, both one repeat unit having formula (II), forming binary copolycarbonates, and several repeat units having formula (II) may be used.

Copolycarbonates in which the repeat unit having formula (I) is derived from 4,4′-dihydroxydiphenyl (DOD) and in which the repeat unit having formula (II) is bisphenol A are particularly preferred.

The first layer preferably has a thickness of 1 to 1000 μm, in particular 10 to 500 μm, in particular 10 to 200 μm, in particular 15 to 60 μm.

In addition to other polycarbonates, the second layer may also contain small amounts, preferably less than 10 wt. %, of the copolymer contained in the first layer.

This multi-layer product is provided by the present invention.

The present invention also provides a process for the production of this multi-layer product by coextrusion.

The present invention also provides a product containing the multi-layer product. This product containing the multi-layer product is preferably selected from the group consisting of glazing panel, protective panel, conservatory, veranda, carport, bus stop, advertising, shop window, window, partition, payment booth, viewing panel, display, roof and film.

The glazing panels may for example be glazing panels for cars or for greenhouses or for petrol stations or for laboratories or for chemical plants.

The protective panels may for example be protective panels in laboratories.

The protective panels may for example serve as housings for machines, to protect them from flying parts that may become loose. Such protective panels are used for example as a replacement for steel cages.

The viewing panels may for example be viewing panels in counters or display cases. The cited viewing panels may for example be used in the food sector.

The definition used for the present invention of the amounts of repeat units in the copolycarbonate according to the invention is as follows. An amount of n mol % means an amount of n mol % relative to the total amounts of all repeat units present in the copolycarbonate. If the amount is 100 mol %, then no other repeat units are present.

The multi-layer product according to the invention presents numerous advantages including chemically resistance, high (notched) impact resistance and high thermal resistance. In addition, it is simple and inexpensive to produce the starting materials are light and available and comparatively inexpensive. Furthermore, the multi-layer product according to the invention features little or no adverse change over the conventional positive properties of polycarbonate, including its good optical properties.

The multi-layer product according to the invention may be produced by coextrusion. This brings about advantages as compared to a product produced by coating. For example, there is no solvent evaporation in coextrusion such as occurs with coating processes.

Furthermore, coating introduces foreign polymers into the coated product. This means for example that for the purposes of recycling the product is no longer a segregated plastic. Coextrusion does not present this disadvantage.

Also, coatings cannot be stored for long periods. Coextrusion does not present this disadvantage.

Additionally, coatings require complex technology. For example, in some cases they require explosion-proof units, the recycling of solvents and hence heavy investment in equipment. Coextrusion does not present this disadvantage.

Compared with a product produced by lamination, the multi-layer product according to the invention offers numerous advantages, because it may be produced by coextrusion.

With lamination a film must first be produced in a separate step. Coextrusion does not present this disadvantage.

Furthermore, coextrusion is simple and the necessary expertise is readily accessible. Lamination is more difficult because the films may blister or warp.

Furthermore, sheets in widths of up to 2.2 metres may easily be produced by coextrusion. By contrast, the films for lamination are mostly only available in a maximum width of 1.6 metres.

A preferred embodiment of the present invention is the multi-layer product where the repeat units having formula (I) are derived from 4,4′-dihydroxydiphenyl (DOD) and where the repeat units having formula (II) are derived from 2,2-bis-(4-hydroxyphenyl) propane, and where the amount of repeat units having formula (I) in the copolycarbonate is 26 to 34 mol % and where the amount of repeat units having formula (II) in the copolycarbonate is 74 to 66 mol %, and where the total amount of repeat units according to formula (I) and formula (II) is 100 mol %.

According to the invention the preferred multi-layer products are ones in which one layer additionally contains 1 to 20 wt. % of UV absorber. The UV absorber is preferably selected from the group consisting of Tinuvin® 360, Tinuvin® 1577 and Uvinul® 3030. These have the following structure:

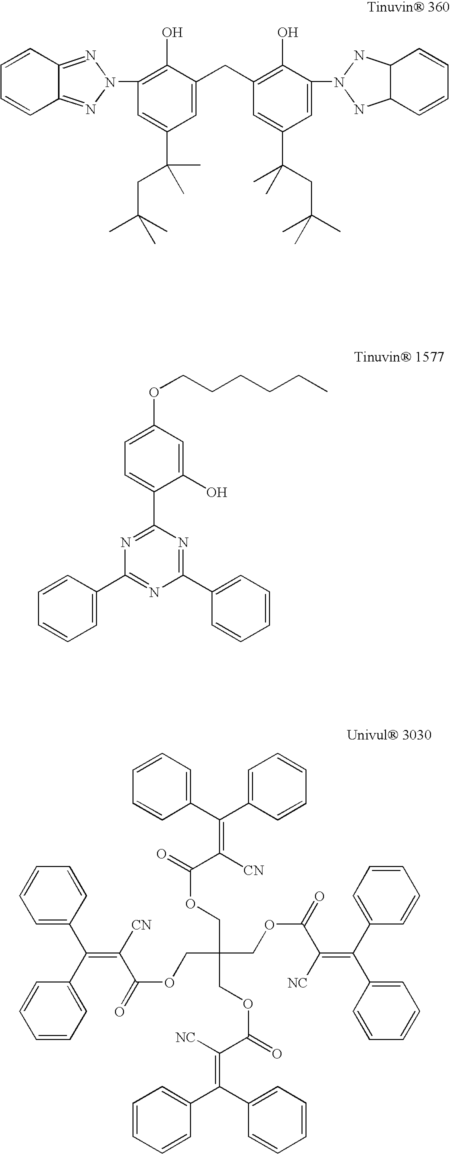

The other layer preferably contains 0 to 1 wt. % of UV absorber. This may be the same or different UV absorbers.

According to the invention the preferred multi-layer products are selected from the group consisting of sheets, pipes, profiles and films.

Sheets may in particular be solid sheets, which in particular may be flat or corrugated. They may also be multi-wall sheets, which in particular may be flat or corrugated.

Multi-wall sheets are sheets in which two outer layers are connected with one another by means of crosspieces, such that cavities are formed inside the sheet. Twin-wall sheets have two outer layers and crosspieces in between them. Triple-wall sheets additionally have a third inner sheet, which is parallel to the two outer sheets. Such multi-wall sheets are described for example in EP-A 0 110 238. There they are called multi-layer hollow chamber plastic sheets. EP-A 0 774 551 also discloses multi-wall sheets. FIG. 1 of EP-A 0 774 551 shows a triple-wall sheet. EP-A 0 054 856 and EP-A 0 741 215 also disclose multi-wall sheets. EP-A 0 110 238, EP-A 0 054 856, EP-A 0 741 215 and EP-A 0 774 551 are hereby incorporated by reference in the present patent application.

The multi-wall sheets may be twin-wall sheets, triple-wall sheets, quadruple-wall sheets, etc. The multi-wall sheets may also have various profiles. Furthermore, the multi-wall sheets may also be corrugated multi-wall sheets.

A preferred embodiment of the present invention is a two-layer sheet or film that include the first and second layer as defined above.

A further preferred embodiment of the present invention is a three-layer sheet or film that contain one layer as the middle layer, which is constructed like the second layer defined above, and two layers as outer layers, both of which are constructed like the first layer defined above.

The multi-layer products according to the invention may for example have the following structure:

a)
DOD-Co-PC (with or without UV absorber)
Other PC (with or without UV absorber)
b)
DOD-Co-PC (with or without UV absorber)
Other PC (with or without UV absorber)
DOD-Co-PC (with or without UV absorber)
c)
DOD-Co-PC (with or without UV absorber)
Other PC (with 0-1% UV absorber)
Other PC (with 0.1-20% UV absorber)

In a special embodiment the multi-layer products are transparent.

The copolycarbonates according to the invention may be produced by known processes. The necessary monomers are known. The monomers and in some cases also the copolycarbonates are commercially available.

4,4′-dihydroxydiphenyl may be produced by various known processes.

It may be produced by the interesterification of diphenyl disulfonic acid with OH⁻ ions or by hydrolysis of dibromodiphenyl or by the process disclosed in EP-A 0 432 782. JP-A 05 097 740, JP-A 0 415 235 and JP A 03 038 538 also disclosed processes for the production of 4,4′-dihydroxydiphenyl.

Copolycarbonates are most particularly preferably constituted from 34-26 mol %, especially 33-27 mol %, in particular 32-28 mol %, most especially 31-29 mol % and most outstandingly 30 mol % of repeat units having formula (I), supplemented in each case by a complementary content of repeat units having formula (II).

Preferred repeat units having formula (I) are derived from 4,4′-dihydroxydiphenyl (DOD) and 4,4′-dihydroxy-3,3′,5,5′-tetra-(tert.-butyl) diphenyl.

Preferred repeat units having formula (II) are derived from 2,2-bis-(4-hydroxyphenyl) propane, 1,1-bis-(4-hydroxyphenyl)-3,3,5-trimethyl cyclohexane and 1,3-[2-(4-hydroxyphenyl)-2-propyl] benzene, 1,1-bis-(4-hydroxyphenyl)-1-phenyl ethane, 1,1-bis-(4-hydroxyphenyl) cyclohexane, in particular 2,2-bis-(4-hydroxyphenyl) propane (bisphenol A).

Both one compound having formula (I), forming binary copolycarbonates, and several compounds having formula (I) may be used.

Likewise, both one compound having formula (II), forming binary copolycarbonates, and several compounds having formula (II) may be used.

The educts having formula (I) and (II) may of course contain impurities arising from synthesis. A high purity is desirable, however, and should be sought, therefore these educts are used in the highest possible purity.

Hereinafter the first layer of the multi-layer product according to the invention is also referred to as the coextrusion layer or coex layer. The second layer is also referred to as the base layer.

Both the coex layer and the base layer may contain additives in particular UV absorbers and heat stabilizers.

The UV absorbers or mixtures thereof are preferably present in the coex layer in concentrations of 0 to 20 wt. %. 0.1 to 20 wt. % are preferable, particularly preferably 2 to 10 wt. %, most particularly preferably 3 to 8 wt. %. If two or more such layers are present, the content of UV absorbers in these layers may differ.

Examples of UV absorbers that may be used according to the invention are described below.

a) Benzotriazole derivatives according to formula (III):

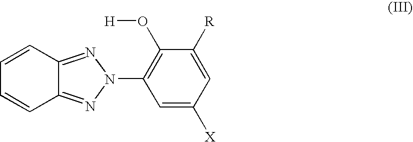

In formula (III) R and X are the same or different and denote H or alkyl or alkyl aryl.

The following are preferred:

Tinuvin® 329 where X=1,1,3,3-tetramethyl butyl and R=H

Tinuvin® 350 where X=tert.-butyl and R=2-butyl

Tinuvin® 234 where X=R=1,1-dimethyl-1-phenyl

b) Dimeric benzotriazole according to formula (IV):

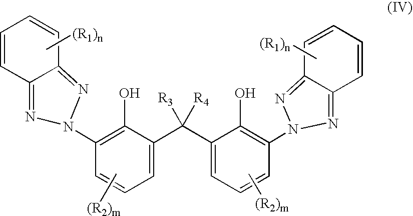

where R¹ and R² independently denote H, halogen, C₁-C₁₀ alkyl, C₅-C₁₀ cycloalkyl, C₇-C₁₃ aralkyl, C₆-C₁₄ aryl, —OR⁵ or —(CO)—O—R⁵ where R⁵=H or C₁-C₄ alkyl.

and R³ and R⁴ independently denote H, C₁-C₄ alkyl, C₅-C₆ cycloalkyl, benzyl or C₆-C₁₄ aryl.

and m denotes 1, 2 or 3 and n is 1, 2, 3 or 4.

The following is preferred:

Tinuvin® 360 where R=R³=R⁴=H, n=4, R²=1,1,3,3-tetramethyl butyl and m=1.

b1) Dimeric benzotriazole derivatives according to formula (V):

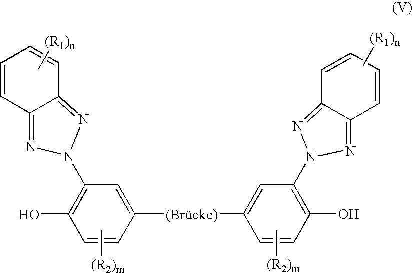

wherein the bridge denotes

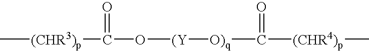

R¹, R², m and n have the meaning cited for formula (IV) and p is a whole number from 0 to 3, q is a whole number from 1 to 10,

Y equals —CH₂—CH₂—, —(CH₂)₃—, —(CH₂)₄—, —(CH₂)₅—, —(CH₂)₆—, or CH(CH₃)—CH₂— and R³ and R⁴ have the meaning cited for formula (II).

The following is preferred:

Tinuvin® 840 where R¹=H, n=4, R²=tert.-butyl, m=1, R² is attached in the ortho position to the OH group, R³=R⁴=H, p=2, Y=—(CH₂)₅—, q=1.

c) Triazine derivatives according to formula (VI):

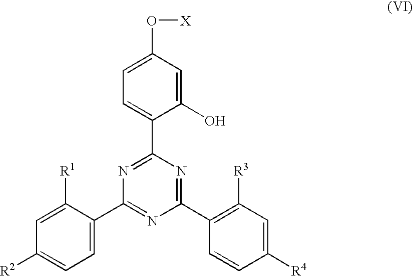

wherein R¹, R², R³, R⁴ in formula (VI) independently are H or alkyl or aryl, or CN or halogen, and X is alkyl.

The following are preferred:

Tinuvin® 1577 where R¹=R²=R³=R⁴H, X=hexyl

Cyasorb® UV-1164 where R¹=R²=R³=R⁴=methyl, X=octyl

d) Triazine derivatives having the formula (VIa)

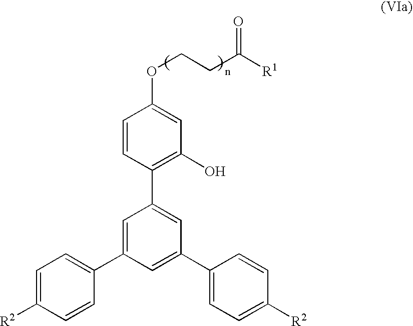

wherein

R¹ denotes C₁ to C₁₇ alkyl,

R² denotes H or C₁ to C₄ alkyl or aryl and

n is equal to 0 to 20.

e) Diaryl cyanoacrylates having the formula (VII):

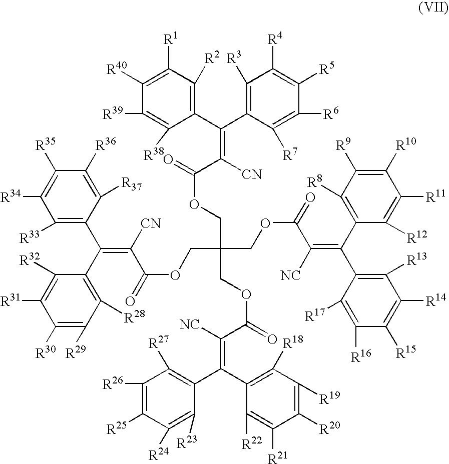

wherein R¹ to R⁴⁰ independently denote H, alkyl, CN or halogen.

Uvinul® 3030 where R¹ to R⁴⁰=H is preferred.

f) Diaryl cyanoacrylates having the formula (VIII):

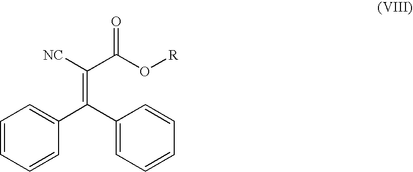

wherein R is C₂ to C₁₀ alkyl or aryl.

Uvinul® 3035 where R=C₂H₅ and Uvinul® 3039 where R=CH₂CH(C₂H₅)C₄H₉ are preferred.

Some of these UV absorbers are commercially available.

In addition to the UV stabilizers, the coex layers and the base layers may also contain other conventional processing aids, in particular release agents and flow control agents, along with the conventional stabilizers in polycarbonates, in particular heat stabilizers, as well as dyes and optical brighteners and inorganic pigments.

Particularly suitable are P-containing heat stabilizers such as phosphines, phosphites and phosphonites. Particularly suitable are for example triphenyl phosphine, diphenyl alkyl phosphites, phenyl dialkyl phosphites, tris(nonylphenyl) phosphite, trilauryl phosphite, trioctadecyl phosphite, distearyl pentaerythritol diphosphite, tris-(2,4-di-tert.-butylphenyl) phosphite, diisodecyl pentaerythritol diphosphite, bis-(2,4-di-tert.-butylphenyl) pentaerythritol diphosphite, bis-(2,6-di-tert.-butyl-4-methylphenyl) pentaerythritol diphosphite, diisodecyl oxypentaerythritol diphosphite, bis-(2,4-di-tert.-butyl-6-methylphenyl) pentaerythritol diphosphite, bis-(2,4,6-tris-(tert.-butylphenyl) pentaerythritol diphosphite, tristearyl sorbitol triphosphite, tetrakis-(2,4-di-tert.-butylphenyl)-4,4′-biphenylene diphosphonite, 6-isooctyloxy-2,4,8,10-tetra-tert.-butyl-12H-dibenzo[d,g]-1,3,2-dioxaphosphocine, 6-fluoro-2,4,8,10-tetra-tert.-butyl-12-methyl-dibenzo[d,g]-1,3,2-dioxaphosphocine, bis-(2,4-di-tert.-butyl-6-methylphenyl) methylphosphite, bis-(2,4-di-tert.-butyl-6-methylphenyl) ethylphosphite, 6-fluoro-2,4,8,10-tetra-tert.-butyl-12-methyl dibenzo[d,g]-1,3,2-dioxaphosphocine, 2,2′,2″-nitrilo[triethyl tris-(3,3′,5,5′-tetra-tert.-butyl-1,1′-biphenyl-2,2′-diyl) phosphite], 2-ethylhexyl-(3,3′,5,5′-tetra-tert.-butyl-1,1′-biphenyl-2,2′-diyl) phosphite, 5-butyl-5-ethyl-2-(2,4,6-tri-tert.-butyl phenoxy)-1,3,2-dioxaphosphirane. Individual compounds or mixtures thereof may be used. Tris-(2,4-di-tert.-butylphenyl) phosphite (Irgafos® 168, Ciba-Geigy), triphenyl phosphine or (2,4,6-tri-tert.-butylphenyl)-(2-butyl-2-ethylpropane-1,3-diyl) phosphite (Ultranox 641®, GE Specialty Chemicals) are particularly preferred.

Other examples of suitable phosphites and phosphonites are:

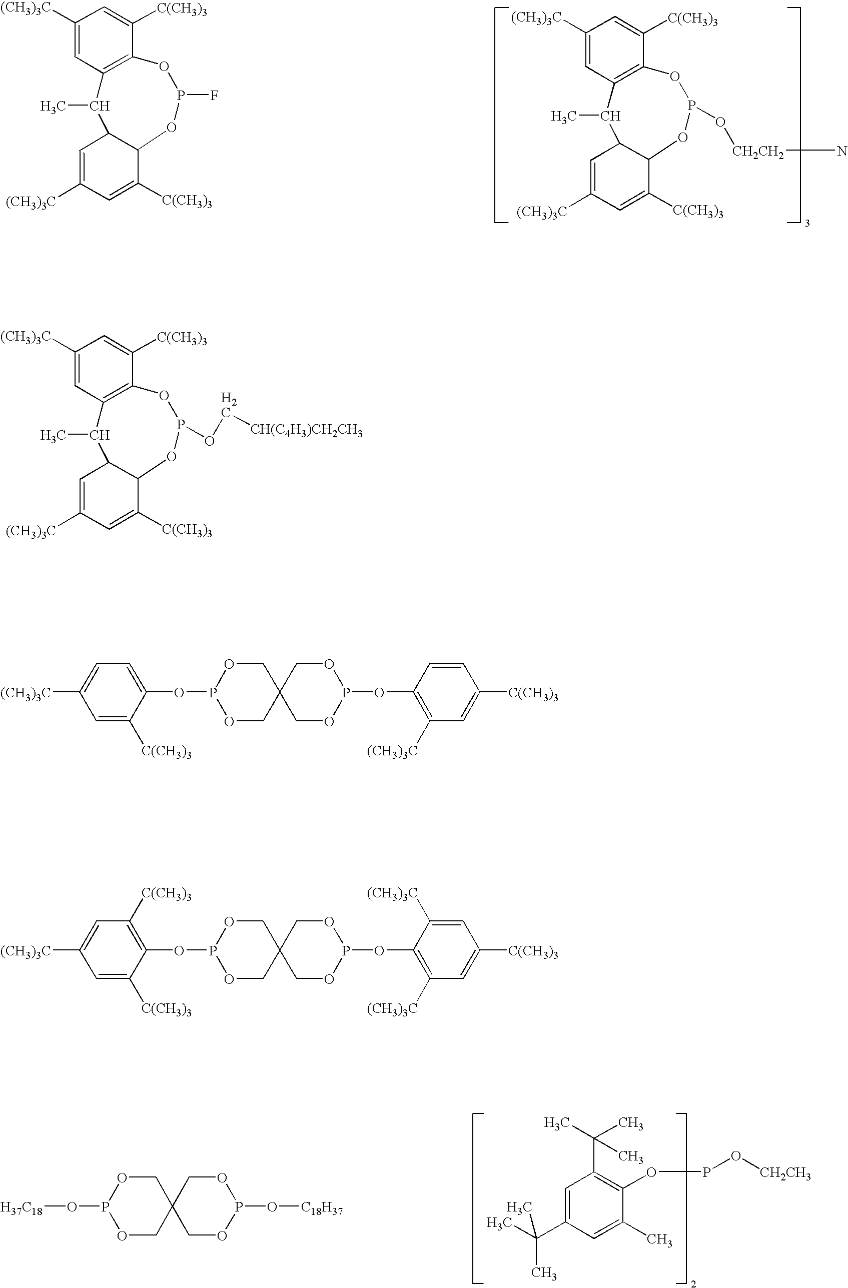

Polycarbonates for the second layer of the multi-layer products according to the invention are all polycarbonates having chemical resistance lower than that of the copolycarbonate of the coex layer.

These include homopolycarbonates, copolycarbonates and thermoplastic polyester carbonates preferably having average molecular weights \overline{M}_{w} of 18,000 to 40,000, more preferably from 26,000 to 36,000 and in particular from 28,000 to 35,000, determined by measuring the relative solution viscosity in dichloromethane or in mixtures of the same amounts by weight of phenol/o-dichlorobenzene calibrated by light scattering.

With regard to the manufacture of polycarbonates, reference is made by way of example to “Schnell, Chemistry and Physics of Polycarbonates, Polymer Reviews, Vol. 9, Interscience Publishers, New York, London, Sydney 1964”, and to “D.C. PREVORSEK, B. T. DEBONA and Y. KESTEN, Corporate Research Center, Allied Chemical Corporation, Moristown, N.J. 07960, ‘Synthesis of Poly(ester)carbonate Copolymers’ in Journal of Polymer Science, Polymer Chemistry Edition, Vol. 19, 75-90 (1980)”, and to “D. Freitag, U. Grigo, P. R. Müller, N. Nouvertne, BAYER AG, ‘Polycarbonates’ in Encyclopedia of Polymer Science and Engineering, Vol. 11, Second Edition, 1988, pages 648-718” and finally to “Drs U. Grigo, K. Kircher and P. R. Müller ‘Polycarbonate’ in Becker/Braun, Kunststoff-Handbuch, Volume 3/1, Polycarbonate, Polyacetale, Polyester, Celluloseester, Carl Hanser Verlag Munich, Vienna 1992, pages. 117-299”.

Production of the polycarbonates is preferably performed by the interfacial polycondensation process or the melt interesterification process and is described below using the interfacial polycondensation process by way of example.

The preferred starting compounds are bisphenols having the general formula

HO-Z-OH,

wherein Z is a divalent organic radical having 6 to 30 carbon atoms and containing one or more aromatic groups.

Examples of such compounds are bisphenols belonging to the group of dihydroxydiphenyls, bis(hydroxyphenyl) alkanes, indane bisphenols, bis(hydroxyphenyl) ethers, bis(hydroxyphenyl) sulfones, bis(hydroxyphenyl) ketones and α,α′-bis(hydroxyphenyl) diisopropyl benzenes.

Particularly preferred bisphenols belonging to the previously cited groups of compounds are bisphenol A, tetraalkyl bisphenol A, 4,4-(meta-phenylene diisopropyl) diphenol (bisphenol M), 4,4-(para-phenylene diisopropyl) diphenol, 1,1-bis-(4-hydroxyphenyl)-3,3,5-trimethylcyclohexane (BP-TMC) and optionally mixtures thereof.

The bisphenol compounds for use according to the invention are preferably reacted with carbonic acid compounds, in particular phosgene, or in the case of the melt interesterification process with diphenyl carbonate or dimethyl carbonate.

Polyester carbonates are preferably obtained by reacting the previously cited bisphenols, at least one aromatic dicarboxylic acid and optionally carbonic acid equivalents Examples of suitable aromatic dicarboxylic acids are phthalic acid, terephthalic acid, isophthalic acid, 3,3′- or 4,4′-diphenyldicarboxylic acid and benzophenone dicarboxylic acids. A part, up to 80 mol %, preferably from 20 to 50 mol %, of the carbonate groups in the polycarbonates may be replaced by aromatic dicarboxylic acid ester groups.

Examples of inert organic solvents used in the interfacial polycondensation process are dichloromethane, the various dichloroethanes and chloropropane compounds, tetrachloromethane, trichloromethane, chlorobenzene and chlorotoluene; chlorobenzene or dichloromethane or mixtures of dichloromethane and chlorobenzene are preferably used.

The interfacial polycondensation reaction may be accelerated by catalysts such as tertiary amines, in particular N-alkyl piperidines or onium salts. Tributylamine, triethylamine and N-ethyl piperidine are preferably used. In the melt interesterification process the catalysts cited in DE-A 4 238 123 are preferably used.

The polycarbonates may be deliberately branched in a controlled manner by the use of small quantities of branching agents. Some suitable branching agents are: phloroglucinol, 4,6-dimethyl-2,4,6-tri-(4-hydroxyphenyl) heptene-2; 4,6-dimethyl-2,4,6-tri-(4-hydroxyphenyl) heptane; 1,3,5-tri-(4-hydroxyphenyl) benzene; 1,1,1-tri-(4-hydroxyphenyl) ethane; tri-(4-hydroxyphenyl) phenyl methane; 2,2-bis-[4,4-bis-(4-hydroxyphenyl) cyclohexyl] propane; 2,4-bis-(4-hydroxyphenyl isopropyl) phenol-2,6-bis-(2-hydroxy-5′-methylbenzyl)-4-methylphenol; 2-(4-hydroxy-phenyl)-2-(2,4-dihydroxyphenyl) propane; hexa-(4-(4-hydroxyphenyl isopropyl) phenyl) orthoterephthalic acid ester; tetra-(4-hydroxyphenyl) methane; tetra-(4-(4-hydroxyphenyl isopropyl) phenoxy) methane; α,α′,α″-tris-(4-hydroxyphenyl)-1,3,5-triisopropyl benzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)methyl) benzene and in particular: 1,1,1-tri-(4-hydroxyphenyl) ethane and bis-(3-methyl-4-hydroxyphenyl)-2-oxo-2,3-dihydroindole.

The 0.05 to 2 mol % of branching agents or mixtures of branching agents that may be incorporated, relative to the diphenols used, may be added together with the diphenols but may also be added at a later stage of the synthesis.

Phenols such as phenol, alkyl phenols such as cresol and 4-tert.-butyl phenol, chlorophenol, bromophenol, cumyl phenol or mixtures thereof are preferably used as chain terminators, in quantities of 1-20 mol %, preferably 2-10 mol % per mol of bisphenol. Phenol, 4-tert.-butyl phenol or cumyl phenol are preferred.

Chain terminators and branching agents may be added to the syntheses either separately or together with the bisphenol.

The production of polycarbonates by the melt interesterification process is described in DE-A 4 238 123 by way of example.

Polycarbonates that are preferred according to the invention for the second layer of the multi-layer product according to the invention are the homopolycarbonate based on bisphenol A, the homopolycarbonate based on 1,1-bis-(4-hydroxyphenyl)-3,3,5-trimethyl cyclohexane and the copolycarbonates based on the two monomers bisphenol A and 1,1-bis-(4-hydroxyphenyl)-3,3,5-trimethyl cyclohexane.

The homopolycarbonate based on bisphenol A is particularly preferred.

The polycarbonate may contain stabilizers. Suitable stabilizers are for example stabilizers containing phosphines, phosphites or silicon and other compounds described in EP-A 0 500 496. Triphenyl phosphites, diphenyl alkyl phosphites, phenyl dialkyl phosphites, tris(nonylphenyl) phosphite, tetrakis-(2,4-di-tert.-butylphenyl)-4,4′-biphenylene diphosphonite and triaryl phosphite may be cited by way of example. Triphenyl phosphine and tris-(2,4-di-tert.-butylphenyl) phosphite are particularly preferred.

These stabilizers may be present in all layers of the multi-layer product according to the invention. In other words both in the so-called base and in the so-called coex layer(s). Different additives or concentrations of additives may be present in each layer.

The multi-layer product according to the invention may also include 0.01 to 0.5 wt. % of the esters or partial esters of monohydric to hexahydric alcohols, in particular of glycerine, pentaerythritol or guerbet alcohols.

Monohydric alcohols are for example stearyl alcohol, palmityl alcohol and guerbet alcohols.

An example of a dihydric alcohol is glycol.

An example of a trihydric alcohol is glycerine.

Examples of tetrahydric alcohols are pentaerythritol and mesoerythritol.

Examples of pentahydric alcohols are arabitol, ribitol and xylitol.

Examples of hexahydric alcohols are mannitol, glucitol (sorbitol) and dulcitol.

The esters are preferably the monoesters, diesters, triesters, tetraesters, pentaesters and hexaesters or mixtures thereof, in particular random mixtures, of saturated, aliphatic C₁₀ to C₃₆ monocarboxylic acids and optionally hydroxy monocarboxylic acids, preferably with saturated, aliphatic C₁₄ to C₃₂ monocarboxylic acids and optionally hydroxy monocarboxylic acids.

The commercially obtainable fatty acid esters, in particular of pentaerythritol and glycerine, may contain <60% of various partial esters as a consequence of their manufacturing process.

Saturated, aliphatic monocarboxylic acids with 10 to 36 C atoms are for example decanoic acid, dodecanoic acid, tetradecanoic acid, hexadecanoic acid, stearic acid, hydroxystearic acid, eicosanoic acid, docosanoic acid, tetracosanoic acid, hexacosanoic acid and octacosanoic acids.

Preferred saturated aliphatic monocarboxylic acids with 14 to 22 C atoms are for example tetradecanoic acid, hexadecanoic acid, stearic acid, hydroxystearic acid, eicosanoic acid and docosanoic acid.

Saturated, aliphatic monocarboxylic acids such as hexadecanoic acid, stearic acid and hydroxystearic acid are particularly preferred.

The saturated aliphatic C₁₀ to C₃₆ carboxylic acids and the fatty acid esters are either known per se from the literature or may be produced by methods known from the literature. Examples of pentaerythritol fatty acid esters are those of the particularly preferred monocarboxylic acids specified above.

Esters of pentaerythritol and of glycerine with stearic acid and hexadecanoic acid are particularly preferred.

Esters of guerbet alcohols and of glycerine with stearic acid and hexadecanoic acid and optionally with hydroxystearic acid are also particularly preferred.

These esters may be present both in the base and in the coex layer(s). Different additives or concentrations may be present in each layer.

The multi-layer products according to the invention may contain antistatics.

Examples of antistatics are cationic compounds, for example quaternary ammonium, phosphonium or sulfonium salts, anionic compounds, for example alkyl sulfonates, alkyl sulfates, alkyl phosphates, carboxylates in the form of alkali-metal salts or alkaline-earth metal salts, non-ionogenic compounds, for example polyethylene glycol esters, polyethylene glycol ethers, fatty acid esters, ethoxylated fatty amines. Preferred antistatics are non-ionogenic compounds.

These antistatics may be present both in the base and in the coex layer(s). Different additives or concentrations may be present in each layer. They are preferably used in the coex layer(s).

The multi-layer products according to the invention may contain organic dyes, inorganic colored pigments, fluorescent dyes and particularly preferably optical brighteners.

These colorants may be present in both the base and in the coex layer(s). Different additives or concentrations may be present in each layer.

All molding compositions used for production of the multi-layer products according to the invention, their feedstocks and solvents, may be contaminated with corresponding impurities as a result of manufacture and storage conditions, the objective being to work with the cleanest possible starting materials.

The individual components may be mixed by known means, both successively and simultaneously, and at both room temperature and elevated temperature.

The additives, in particular the UV absorbers and other aforementioned additives, are preferably incorporated into the molding compositions according to the invention by known means by mixing polymer granules with the additives at temperatures from around 200 to 330° C. in conventional units such as internal mixers, single-screw extruders and double-shaft extruders for example by melt compounding or melt extrusion or by mixing the polymer solutions with solutions of the additives, followed by evaporation of the solvents by known means. The content of additives in the molding composition may be varied between broad limits and is governed by the desired properties of the molding composition. The total content of additives in the molding composition is preferably up to around 20 wt. %, preferably 0.2 to 12 wt. %, relative to the weight of the molding composition.

The UV absorbers may for example also be incorporated into the molding compositions by mixing solutions of the UV absorbers and optionally other aforementioned additives with solutions of the plastics in suitable organic solvents such as CH₂Cl₂, haloalkanes, haloaromatics, chlorobenzene and xylenes. The mixtures of substances are then preferably homogenized by known means via extrusion; the solution mixtures are preferably removed by known means by evaporating the solvent, followed by extrusion, for example compounding.

As the examples show, the use of the coextrusion molding compositions according to the invention offers a significant advantage on any inadequately chemically resistant polycarbonate molding compositions as base material.

The multi-layer products according to the invention may be processed e.g. by thermoforming or by surface treatments, such as e.g. application of scratch-resistant coatings, water-spreading layers and similar, and the products produced by these processes are likewise provided by the present invention.

Coextrusion is known per se from the literature (see for example EP-A 0 110 221 and EP-A 0 110 238). In the present case the procedure is preferably performed as follows. Extruders are connected to a coextrusion adapter to produce the core and outer layer(s). The adapter is designed in such a way that the melts forming the outer layer(s) are applied adhesively as a thin layer to the melt of the core. The multi-layer melt strand produced in this way is then transferred to the adjacent die in the desired form (multi-wall sheet or solid sheet). The melt is then cooled under controlled conditions by known means by calendering (solid sheet) or vacuum calibration (multi-wall sheet) and then cut into lengths. A conditioning oven may optionally be connected after the calibration stage to eliminate stresses. In place of the adapter connected before the die, the die itself may also be designed in such a way that the melts are brought together there.

The invention is further explained by, without being limited to, the following examples. The examples according to the invention merely describe preferred embodiments of the present invention.

### EXAMPLES

The material referred to as DOD-CoPC below is a polycarbonate (MVR 7.1) derived of 30 mol % dihydroxydiphenyl (DOD) and 70 mol % bisphenol A that was produced by the interfacial polycondensation process. The chain terminator was 4-tert.-butyl phenol.

Products in accordance with the invention were prepared and their properties evaluated. The base layer in all instances was a 4 mm thick made of Makrolon® 3103 (a UV protected linear homopolycarbonate based on bisphenol A (a product of Bayer AG, Leverkusen, Germany) having melt flow rate (MFR) of 6.5 g/10 min at 300° C. and 1.2 kg loading (measured according to ISO 1133).

The compositional makeup of the coex layers is as follows:

Example A—Makrolon 3100 (linear bisphenol A based homopolycarbonate, a product of Bayer AG (MFR=6.5 g/10).

Example B—Makrolon 3100 and 0.25 wt % of Tinuvin 329.

Example C—DOD-CoPC

Example D—DOD-CoPC and 0.25 wt % of Tinuvin 329.

The thickness of each of the coex layer was about 50 μm.

*) Tinuvin® 329 is 2-(2-hydroxy-5-tert.-octylphenyl) benzotriazole, a product of Ciba Spezialitätenchemie, Lampertheim, Germany

The machines and equipment used to produce the multi-layer solid sheets are described below:

The apparatus consisted of

the main extruder with a screw of length 33 D and a diameter of 60 mm with venting

the coex adapter (feedblock system)

a coextruder for applying the outer layer with a screw of length 25 D and a diameter of 30 mm

the special sheet extrusion die with a width of 350 mm

the polishing stack

the roller conveyor

the take-off unit

the flying knife (saw)

the stacking table.

The polycarbonate granules forming the base material were supplied to the feed hopper for the main extruder, the coextrusion material to that for the coextruder. In each case the material was melted and conveyed in the corresponding plasticising system (cylinder/screw). Both material melts were brought together in the coex adapter and formed a composite after leaving the die and being cooled in the calender. The other equipment served to transport, cut to length and stack the coextruded sheets.

The text specimens were tested for their resistance to various chemicals found in the home by means of the test below:

Double-sided adhesive tape (5 mm wide) was affixed to a sheet measuring 110×35 mm×4 mm in such a way that a compartment measuring 4.5 cm×2.5 cm was produced. After being stretched onto an outer fibre strain template (number “99”; outer fibre strain 2% with 4 mm sheets according to DIN 53449 Part 3) a piece of cotton measuring 3 cm×1 cm soaked in the test medium was placed in the centre of the compartment and closed off with aluminium foil. Since the sheets were wider than the template, the onset and progress of cracking could be readily observed through the back.

The table below points to that sheets according to the invention (C and D) have a better resistance to chemicals found in the home than the comparative sheets A and B.

The comparison with the test with premium fuel shows that the sheets according to the invention surprisingly display a higher resistance to household chemicals than to fuel.

| | Exposure | | | | |
|---|---|---|---|---|---|
| | time | Sheet A | Sheet B | Sheet C | Sheet D |
| Test with | 20 min | Large | Large | Large | Large |
| premium | | number of | number of | number of | number of |
| fuel¹⁾ | | severe | severe | severe | severe |
| | | cracks | cracks | cracks | cracks |
| Test with | 30 min | Fine | Fine | No cracks | No cracks |
| skin cream²⁾ | | cracks | cracks | | |
| Test with | 2 h | Some | Some | No cracks | No cracks |
| cold-pressed | | severe | severe | | |
| olive oil³⁾ | | cracks | cracks | | |
| Test with | 2 h | Broken | Broken | Several | Several |
| perfume⁴⁾ | | | | deep | deep |
| | | | | cracks | cracks |

¹⁾Premium fuel from Shell
²⁾Skin cream from Physioderm GmbH & Co. KG
³⁾Manufacturer: Oleificio R.M: S.P.A. Lucca, Italy (trade name of TIP)
⁴⁾Jil Sander Woman III (contains inter alia water, ethanol and ethereal oils)

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A multi-layer product comprising a coex layer and a base layer, where the coex layer contains a copolycarbonate derived from 0.1 to 46 mol % of one or more repeat units having the formula (I) 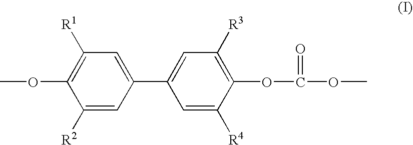
where R¹ to R⁴ independently denote H, C₁ 1 to C₄ alkyl, phenyl, substituted phenyl or halogen, and 99.9 to 54 mol % of one or more repeat units having the formula (II) 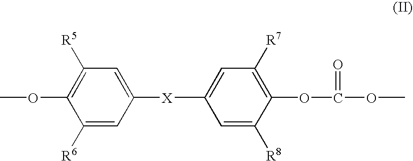
where R⁵ to R⁸ independently denote H, CH₃, Cl or Br and X is C₁ to C₅ alkylene, C₂ to C₅ alkylidene, C₅ to C₆ cycloalkylene, or C₅ to C₁₀ cycloalkylidene, where the total amount of repeat units according to formula (I) and formula (II) is 100 mol %,
and where the base layer contains a polycarbonate characterized in that its chemical resistance is lesser than that of said copolycarbonate.

2. The product according to claim 1, where formula (I) denotes 4,4′-dihydroxydiphenyl (DOD) and formula (II) denotes 2,2-bis-(4-hydroxyphenyl) propane, and where the amount of repeat units of formula (I) is 26 to 34 mol % and the amount of repeat units of formula (II) is 74 to 66 mol %.

3. The product according to claim 1 where the base layer contains a polycarbonate selected from the group consisting of the homopolycarbonate based on bisphenol A, homopolycarbonate based on 1,1-bis-(4-hydroxyphenyl)-3,3,5-trimethyl cyclohexane and copolycarbonate based on bisphenol A and 1,1-bis-(4-hydroxyphenyl)-3,3,5-trimethyl cyclohexane.

4. The product according to claim 1 where the base layer contains a homopolycarbonate based on bisphenol A.

5. The product according to claim 1 in the form of a member selected from the group consisting of sheets, pipes, profiles and films.

6. The product according to claim 1 where the coex layer additionally contains 0.1 to 20 wt. % of UV absorber.

7. The product according to claim 6, whereby the UV absorber conforms to a formula selected from the group consisting of

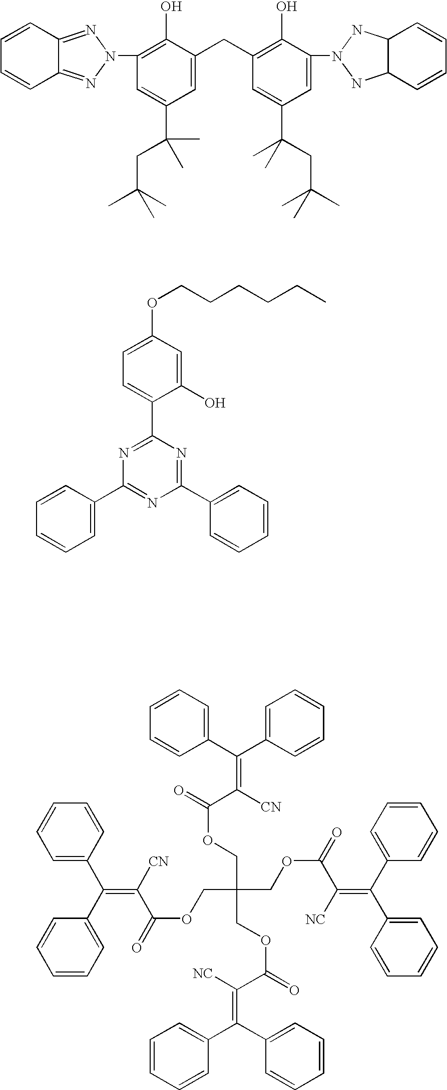

8. A process for the production of product according to of claims 1 to 7 claim 1 comprising co-extruding the coex layer and base layer.
